(19) United States
(12) Patent Application Publication
(10) Pub. No.: US 2026/0023504 A1
(43) Pub. Date: Jan. 22, 2026

(54) HIGH ENDURANCE TRIM VALUES FOR NONPERFORMANCE-TYPE WRITE COMMANDS

(71) Applicant: Micron Technology, Inc., Boise, ID (US)

(72) Inventors: Gary F. Besinga, Boise, ID (US); Tawalin Opastrakoon, Boise, ID (US); Michael G. Miller, Boise, ID (US); Cory M. Steinmetz, Boise, ID (US); Che Chen, Boise, ID (US)

(21) Appl. No.: 19/024,084

(22) Filed: Jan. 16, 2025

Related U.S. Application Data
(60) Provisional application No. 63/556,180, filed on Feb. 21, 2024.

(51) Int. Cl. G06F 3/06

(52) U.S. Cl. CPC G06F 3/0659; G06F 3/0604; G06F 3/0679

(57) ABSTRACT

Technologies directed to trim values for different types of write commands is described. A controller may receive a write command to be performed on a set of memory cells of a memory device. The write command may be of a first type or a second type. The controller may select a set of trim values based on the write command being of the first type or the second type. The write command may be executed with the selected set of trim values.

### RELATED APPLICATIONS

This application claims the benefit of U.S. Provisional Patent Application No. 63/556,180, filed Feb. 21, 2024, which is incorporated by reference herein.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example computing system that includes a memory sub-system, according to one embodiment.

FIG. 2 is a graph illustrating programming pulse characteristics, according to one embodiment.

FIG. 3 is a flowchart illustrating a decision process between sets of trim values, according to one embodiment.

FIG. 4 illustrates a method 400 in accordance with one embodiment.

FIG. 5 illustrates an example machine of a computer system within which a set of instructions, for causing the machine to perform any one or more of the methodologies discussed herein, can be executed.

### DETAILED DESCRIPTION

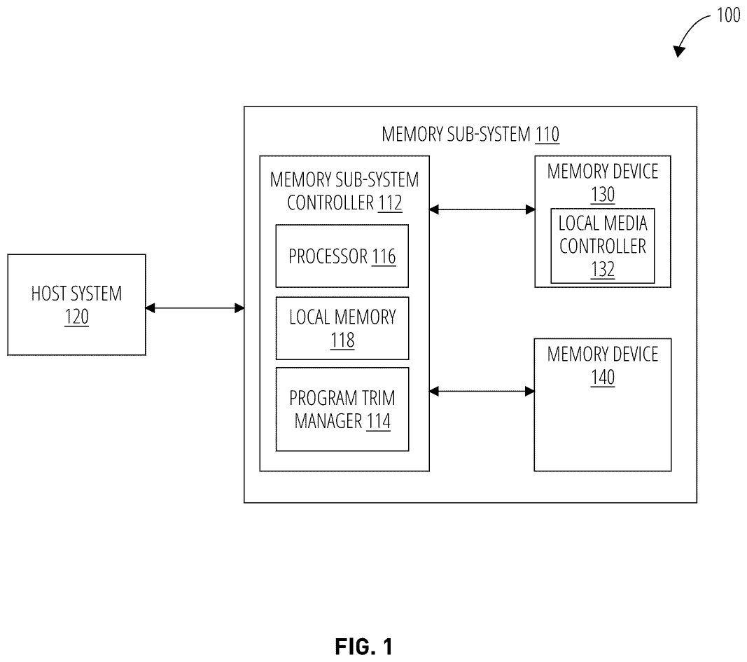

Technologies directed to trim values for different types of write commands is described. A memory sub-system can be a storage device, a memory module, or a combination of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. In some embodiments, non-volatile memory devices can be provided by negative-and (NAND) type flash memory devices. Other examples of non-volatile memory devices are described below in conjunction with FIG. 1. For some types of non-volatile memory devices (e.g., NAND devices), each plane includes a set of physical blocks. Each block includes a set of pages. “Block” herein shall refer to a set of contiguous or non-contiguous memory pages. An example of a “block” is an “erasable block,” which is the minimal erasable unit of memory, while “page” is a minimal writable unit of memory. Each page includes a set of memory cells. A memory cell is an electronic circuit that stores information.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

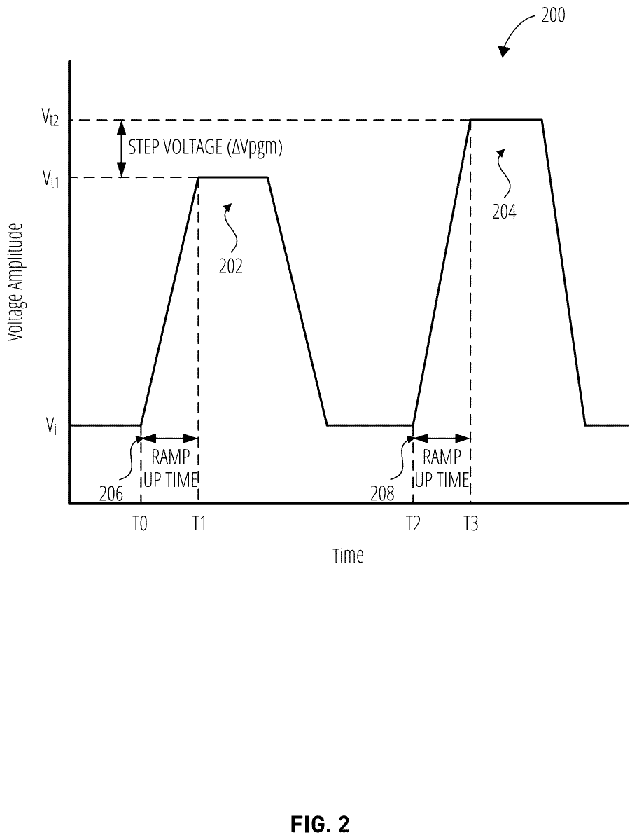

As described above, a memory device includes multiple memory cells, each of which can store, depending on the memory cell type, one or more bits of information. A memory cell can be programmed (written to) by applying a certain voltage to the memory cell, which results in an electric charge being held by the memory cell, thus allowing modulation of the voltage distributions produced by the memory cell. Voltage may be applied to the memory cell through multiple programming pulses. Programming pulses may have several relevant characteristics, such as a ramp up time, start voltage, and step voltage. As used herein, “ramp up time” refers to a duration of time before the programming pulse rises to a target voltage level. In some embodiments, a target voltage level may refer to a desired voltage level of a corresponding programming pulse. Another relevant characteristic of voltage pulses may be a start voltage. As used herein, “start voltage” refers a target voltage of an initial programming pulse (e.g., Vₜ₁ as described in FIG. 2) sent to the memory cell. In some embodiments, “start voltage” may be referred to as Vpgm. Another relevant characteristic of a voltage pulse may be a step voltage. As used herein, “step voltage” refers to a difference between iterative voltage pulses. In some embodiments, “step voltage” may be referred to as ΔV_{pgm}.

In some embodiments, programming pulses may allow for precise controlling of the amount of the electric charge stored by the memory cell allows to establish multiple threshold voltage levels corresponding to different logical levels, thus effectively allowing a single memory cell to store multiple bits of information: a memory cell operated with 2ⁿ different threshold voltage levels is capable of storing n bits of information. Thus, a read operation can be performed by comparing the measured voltage exhibited by the memory cell to one or more reference voltage levels in order to distinguish between two logical levels for single-level cells and between multiple logical levels for multi-level cells.

Characteristics of programming pulses may affect performance of a memory device. For example, a faster ramp up time may lead to a lower write latency (e.g., quicker data writing) and lower power consumption. However, the faster ramp up time may also increase stress on the corresponding memory cell(s) and reduce a total bytes written (TBW) of the memory device. Conversely, a slower ramp up time may result in lower performance characteristics (e.g., higher write latency, longer programming time, higher power consumption) but higher endurance characteristics (e.g., TBW). In some embodiments, raising or lowering start voltages and step voltages of programming pulses also exhibits a similar tension between performance and endurance characteristics of a memory device. Conventionally, the tension is ignored and the memory device performs programming pulses using a single set of trim values, which may be designed to enhance performance characteristics of the memory device. So, conventionally, a programming operation on a single-level cell (SLC) memory device uses a same set of trim values when programming user blocks and firmware table blocks. Thus, conventional approaches to trim values fail to balance both performance and endurance considerations with regard to programming operations. While a write latency may be relevant to some write operations, such as host-initiated write operations, write latency may be of lesser concern for other write operations. Thus, a higher endurance may be achieved by using a set of trim values that are less aggressive (e.g., lower start voltage, lower step voltage, longer ramp up time, or a combination thereof) when executing these operations.

Aspects of the present disclosure address the above and other deficiencies by providing multiple sets of trim values each corresponding to the types of programming operation(s). “Trim values” may refer to values related to programming pulse characteristics such as ramp up time, start voltage, step voltage, or the like. One or more sets of trim values may be stored by the memory device. Each set of trim values may correspond of define characteristics of unique programming pulses. The one or more sets of trim values may be stored by read-only memory (ROM) of the memory device. In some embodiments, the ROM may be fuses or any other device capable of storing firmware or otherwise embedded software. A controller of the memory device (i.e., a memory sub-system controller, a memory device controller, etc.) can determine which set of trim values is to be used by the memory device prior to execution of a programming operation. The controller may determine the set of trim values for a programming operation in order to emphasize one of performance or endurance of the memory device. For example, upon receiving a performance-type programming command, such as a programming command from a host device, the controller may select a set of trim values designed to enhance performance characteristic(s) of the memory device. However, if the write command corresponds to an endurance-type (e.g., nonperformance-type) programming operation, such as a media management operation (e.g., garbage collection), the controller may select a set of trim values designed to enhance endurance characteristic(s) of the memory device. Accordingly, the controller may utilize different sets of trim values during a lifetime of the memory device to enhance endurance characteristic(s) of the memory device when a programming operation is an endurance-type programming operation.

Advantages of the present disclosure include, but are not limited to, increasing TBW of a memory device by using less aggressive programming pulses when nonperformance-type programming operations. By using less aggressive programming pulses (e.g., longer ramp up time, lower start voltage), an amount of blocks needed to satisfy a TBW requirement can be reduced.

FIG. 1 illustrates an example computing system 100 that includes a memory sub-system 110, according to one embodiment. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device that is also a data storage device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 112 (or controller 112 for simplicity) can communicate with the memory devices 130 to perform operations such as reading data, writing data, or erasing data at the memory devices 130 and other such operations. The memory sub-system controller 112 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 112 can be a microcontroller, special purpose logic circuitry (e.g., a field programmable gate array (FPGA), an application specific integrated circuit (ASIC), etc.), or other suitable processor.

The memory sub-system controller 112 can include a processing device, which includes one or more processors (e.g., processor 116), configured to execute instructions stored in a local memory 118. In the illustrated example, the local memory 118 of the memory sub-system controller 112 includes an embedded memory configured to store instructions for performing various processes, operations, logic flows, and routines that control operation of the memory sub-system 110, including handling communications between the memory sub-system 110 and the host system 120.

In some embodiments, the local memory 118 can include memory registers storing memory pointers, fetched data, etc. The local memory 118 can also include read-only memory (ROM) for storing micro-code. While the example memory sub-system 110 in FIG. 1 has been illustrated as including the memory sub-system controller 112, in another embodiment of the present disclosure, a memory sub-system 110 does not include a memory sub-system controller 112, and can instead rely upon external control (e.g., provided by an external host, or by a processor or controller separate from the memory sub-system).

In general, the memory sub-system controller 112 can receive commands or operations from the host system 120 and can convert the commands or operations into instructions or appropriate commands to achieve the desired access to the memory devices 130. The memory sub-system controller 112 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 112 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 112 and decode the address to access the memory devices 130.

In some embodiments, the memory devices 130 include local media controller(s) 132 that operate in conjunction with memory sub-system controller 112 to execute operations on one or more memory cells of the memory devices 130. An external controller (e.g., memory sub-system controller 112) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 112) for media management within the same memory device package. An example of a managed memory device is a managed NAND (MNAND) device.

The memory sub-system 110 includes a program trim manager 114 that can manage trim values for one or more portions of a memory device 130. In some embodiments, the memory sub-system controller 112 includes at least a portion of the program trim manager 114. For example, the memory sub-system controller 112 can include a processor 116 (processing device) configured to execute instructions stored in local memory 118 for performing the operations described herein. In some embodiments, the program trim manager 114 is part of the host system 120, an application, or an operating system.

The program trim manager 114 can be configured to manage sets of trim values. “Trim values” or “trims” may refer to configuration data used to determine programming pulse characteristics such as ramp up time, start voltage, step voltage, or the like. Programming pulse characteristics determined with the configuration data may include, e.g., a ramp up time, a start voltage, or a step voltage. In some embodiments, other programming pulse characteristics may be determined with the configuration data. Further details regarding the trim values are provided below with respect to FIG. 2. Each trim value may correspond to one of the ramp up time, the start voltage, or the step voltage. Trim values may be stored within a portion of the memory device 130. In one embodiment, at least one set of trim values may be stored by fuses within the memory device 130. The fuses can be used to store configuration data by permanently altering a state of each fuse through a one-time programmable process, thereby providing reliable and non-volatile retention of the configuration data. In another embodiment, more than one one set of trim values may be stored in registers. While the above description provides that set(s) of trim values may be stored by fuses, set(s) of trim values may also be stored by other types of ROM.

In various embodiments, a default set of trim values may be stored by ROM, as described above. During the initialization of the memory device, this default set of trim values may be loaded to a set of latches (e.g., static random access memory (SRAM)). After the default set of trim values is loaded to the set of latches, algorithms of the memory device, including write operations, are executed based on the values stored in the set of latches. By modifying one or more values stored on the set of latches, algorithms of the memory device can be executed based on a second set of trim values different than the default set of trim values. As such, the second set of trim values may be used when executing write operations by modifying at least one latch of the set of latches that initially stored the default set of trims. A latch of the set of latches may be modified by enabling the latch. In at least some embodiments, enabling the latch may mean causing the latch to output a different value. In various embodiments, the second set of trim values may also be stored by fuses. In some embodiments, more than two sets of trim values may be selected from before executing a write command. Each write command may be performed on a set of memory cells of the memory devices 130, 140.

In some embodiments, the program trim manager 114 may select a set of trim values from multiple sets of trim values to be used when executing a write command. A first set of trim values may be designed to enhance performance of the memory device 130, while a second set of trim values may be designed to increase endurance of the memory device 130. In some embodiments, to enhance performance of the memory device 130, the first set of trim values may be designed for quicker data writing. However, quicker data writing may incur high levels of stress on individual memory cells, which may detrimentally affect an endurance characteristic of the memory device 130. One endurance characteristic that may be affected by quicker data writing may be a total bytes written (TBW) rating of the memory device 130. Conversely, to enhance endurance of the memory device 130 (e.g., cause a higher endurance characteristic of the memory device 130), the second set of trim values may be designed to reduce stress on individual memory cells and increase a TBW rating (i.e., enhance or increase an endurance characteristic) of the memory device 130.

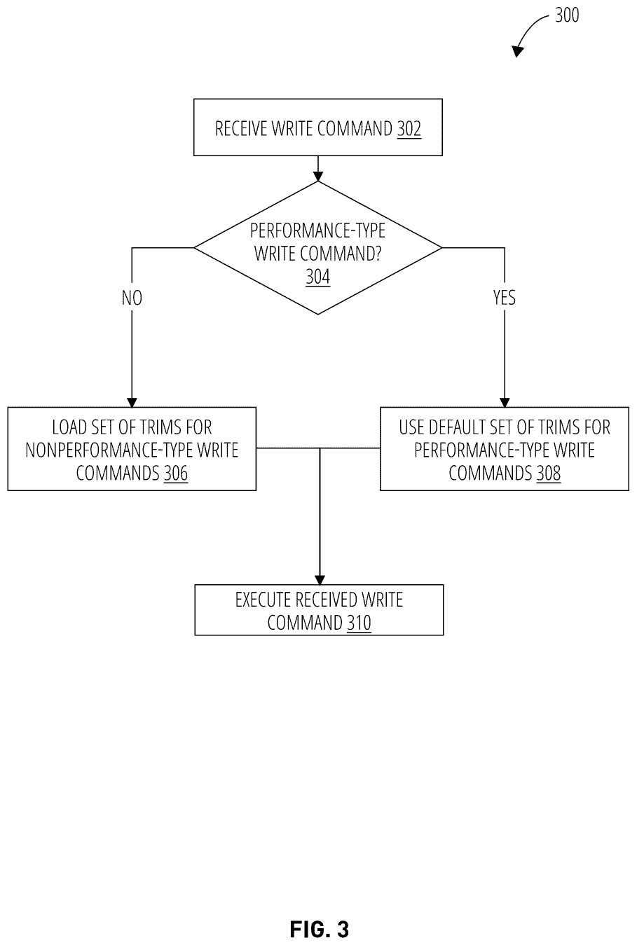

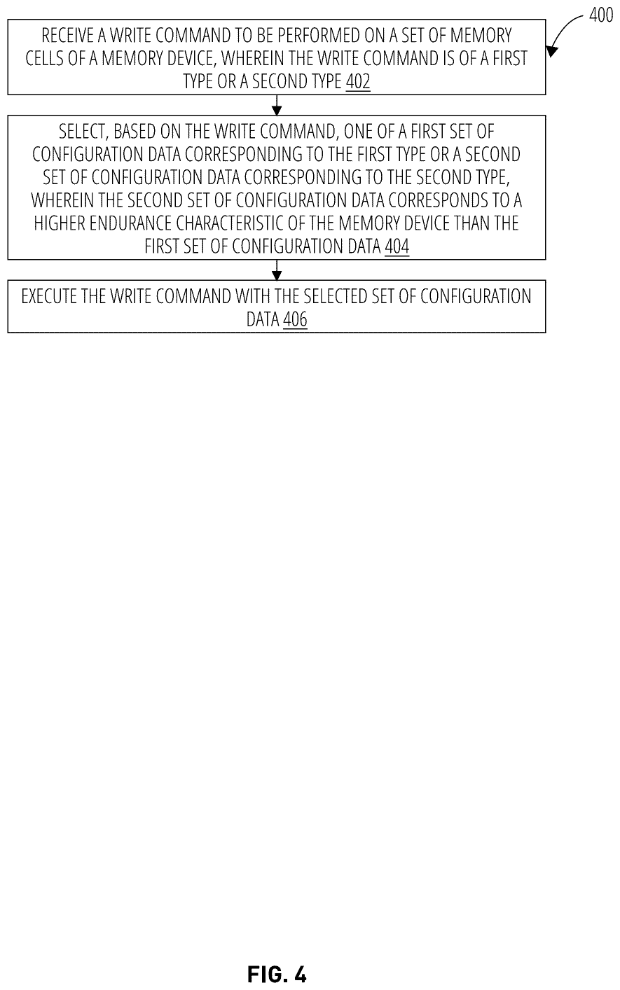

To select which set of trim values to use when executing a write command, the program trim manager 114 may determine whether the write command is a performance-type write command or a non-performance-type write command. In some embodiments, performance-type write commands are write commands to which write latency is relevant. Write latency may refer to a total duration from initiation of the write command to finalization of data storage in the memory device 130. Some examples of performance-type write commands may be some or all write commands originating from the host system 120 or critical flash translation layer (FTL) journal write commands. Some examples of nonperformance-type write commands may be media management operations (e.g., media management block refresh, garbage collection during idle time), error handling operations (e.g., error handling block refresh) and non-critical FTL journal writes. Further details regarding the determination process of which set of trim values to use when executing a write command are provided below with respect to FIGS. 3-4.

FIG. 2 is a graph 200 illustrating programming pulse characteristics, according to one embodiment. The illustrated programming pulses (i.e., first programming pulse 202, second programming pulse 204) may be sent to a memory cell of a memory device, such as the memory device 130 as described above with respect to FIG. 1. In some embodiments, the programming pulse characteristics described with respect to FIG. 2 may be determined by set(s) of configuration data (e.g., trim values) stored within fuses, registers, or other non-volatile memory of the memory device.

In some embodiments, the first programming pulse 202 includes characteristics such as a first target voltage Vₜ₁ and a first ramp up time 206. The first target voltage Vₜ₁ may be a specific voltage level that the first programming pulse 202 is designed to reach based on a selected set of trim values. In embodiments where the first target voltage Vₜ₁ is an initial programming pulse to be sent to the memory cell, the first target voltage Vₜ₁ is the start voltage. In some embodiments, the start voltage is a minimum voltage to be applied to a memory cell during programming (e.g., a write operation). The start voltage may be determined based on the selected set of trim values. A higher start voltage may increase performance of the memory device by speeding up write operations and reducing write latency. A higher start voltage may be desired for performance-type write commands, as described above with respect to FIG. 1. Over time, however, the higher start voltage may cause more wear on the memory cell (e.g., NAND cell) than a lower start voltage. Excessive wear may lead to a higher error rate and an increased frequency of error correction operations, which may slow down performance of the memory device. Additionally, using a higher start voltage for every write operation may detrimentally affect a TBW rating of the memory device.

In some embodiments, the first ramp up time 206 is a duration of time the first programming pulse 202 takes to reach the first target voltage Vₜ₁ from an initial voltage Vᵢ. The first ramp up time 206 may correspond to a slope of the ramping voltage. The slope corresponding to the first ramp up time 206 may be equal to (Vₜ₁−Vᵢ)÷(T1−T0). The initial voltage Vᵢ may be about zero volts (0V). The duration of the first ramp up time 206 may be designed to last a specific amount of time based on the selected set of trim values. Similar to a higher start voltage, a shorter ramp up time may increase performance of the memory device by speeding up write operations and reducing write latency. A shorter ramp up time may be desired for performance-type commands, as described above with respect to FIG. 1. Over time, however, a shorter ramp up time may cause more wear on the memory cell than a longer ramp up time. Excessive wear may lead to a higher error rate and an increased frequency of error correction operations, which may slow down performance of the memory device. Additionally, using a shorter ramp up time for every write operation may detrimentally affect the TBW rating of the memory device.

In some embodiments, the second programming pulse 204 includes same or similar characteristics to the first programming pulse 202. Characteristics of the second programming pulse 204 may include a second target voltage Vₜ₂ and a second ramp up time 208. The second target voltage Vₜ₂ may be a specific voltage level that the second programming pulse 204 is designed to reach based on the selected set of trim values. The second target voltage Vₜ₂ may be equal to the first target voltage Vₜ₁ combined with a step voltage ΔV_{pgm}.

In some embodiments, the second ramp up time 208 is a duration of time the second programming pulse 204 takes to reach the second target voltage Vₜ₂ from an initial voltage Vᵢ. The second ramp up time 208 may correspond to a slope of the ramping voltage. The slope corresponding to the second ramp up time 208 may be equal to (Vₜ₂−Vᵢ)÷(T3−T2). The duration of the second ramp up time 208 may be designed to last a specific amount of time based on the selected set of trim values. In some embodiments, the duration of the second ramp up time 208 is the same as the duration of the first ramp up time 206. In other embodiments, the slope corresponding to the second ramp up time 208 is the same as the slope corresponding to the first ramp up time 206.

The step voltage ΔV_{pgm} may also be determined by the selected set of trim values. In some embodiments, the step voltage ΔV_{pgm} may be added (or subtracted) to successive programming pulses. For example, a third target voltage of a third programming pulse (not shown) immediately following the second programming pulse 204 may be equal to Vₜ₂+ΔV_{pgm}, or Vₜ₁+2(ΔV_{pgm}). The step voltage ΔV_{pgm} may (i) increase, (ii) decrease, or (iii) stay the same with each successive programming pulse. A higher step voltage ΔV_{pgm} may increase performance of the memory device by speeding up write operations and reducing write latency, similar to a shorter ramp up time or higher start voltage. As such, a higher step voltage may be desired for performance-type commands, as described above with respect to FIG. 1. Over time, however, a higher step voltage ΔV_{pgm} may cause more wear on memory cells than a lower step voltage. Excessive wear may lead to a higher error rate and an increased frequency of error correction operations, which may slow down performance of the memory device. Additionally, using a higher step voltage for every write operation may detrimentally affect the TBW rating of the memory device.

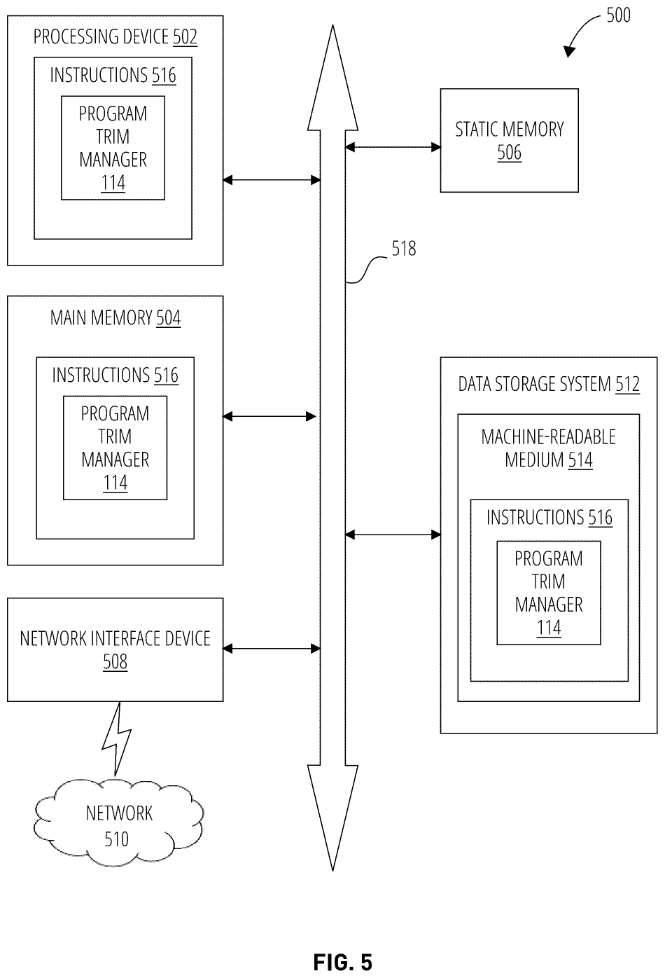

FIG. 3 is a flowchart 300 illustrating a decision process between sets of trim values, according to one embodiment. The flowchart 300 may be implemented by hardware, software, firmware, or a combination thereof. In at least one embodiment, the flowchart 300 is performed by a processing logic comprising hardware, software, firmware, or a combination thereof. The processing logic may be a controller, such as the memory sub-system controller 112 or local media controller 132 of FIG. 1, a processing device, a computing device, or other electronic devices. In some embodiments, the processing logic may be comprised of multiple processing devices. In at least one embodiment, a computing system performs the operations of the program trim manager 114, such as the computing system 100 of FIG. 1 or computer system 500 of FIG. 5.

At block 302, the processing logic may receive a write command. The processing logic may receive a write command generated by a host system, such as the host system 120 of FIG. 1, or from the memory sub-system controller (e.g., to determine when media management operations should take place). Write commands received from internal algorithms may be generated by the processing logic.

At decision block 304, the processing logic may determine whether the received write command is a performance-type write command. The received write command may be a performance-type write command if write latency is relevant to the write command. Write latency may refer to a total duration from initiation of the write command to finalization of data storage in the memory device 130. Write latency may be relevant if (i) the host system (e.g., host system 120) may be detrimentally affected by a longer write latency, or (ii) a longer write latency may cause a bottleneck. A longer write latency may cause a bottleneck if the computing system is handling write-intensive tasks where data needs to be written to storage quickly and efficiently, such as in high-performance computing environments, real-time data processing, or in situations where multiple applications (e.g., internal algorithms, host systems) are concurrently sending write commands systems to the processing logic. Some examples of performance-type write commands may be some or all write commands initialized by the host system or write commands related to a journaling operation other than firmware (FW) or flash translation layer (FTL) table journaling operations. If the processing logic determines that the received write command is a performance-type write command, the processing logic may use a default set of trim values at block 308.

Some examples of nonperformance-type write commands may be media management operations (e.g., media management block refresh, garbage collection during idle time), error handling operations (e.g., error handling block refresh), FT journaling operations, or FTL journaling operations. Here, write latency may be of lesser concern, and thus higher endurance may be achieved by using a set of trim values that are less aggressive (e.g., lower start voltage, lower step voltage, longer ramp up time) when executing these operations. If the processing logic determines that the received write command is a nonperformance-type write command, the processing logic may use a loads a set of trim values for nonperformance-type write commands at block 306.

At block 310, the processing logic may execute the received write command with the selected set of trim values. In some embodiments, the selected trim values may be the default set of trim values or the loaded set of trim values. The loaded set of trim values may be selected by enabling one or more latches coupled to storage component(s) storing the default set of trim values. In some embodiments, the processing logic may cause firmware of the memory device (e.g, memory device 130) to load the set of trim values for nonperformance-type write commands. In various embodiments, the processing logic may send a command to the portion of the memory device where the write command is to be executed that indicates which set of trim values is to be used when executing the received write command.

FIG. 4 illustrates a method 400 of executing a write command, according to one embodiment. The method 400 may be implemented by hardware, software, firmware, or a combination thereof. In at least one embodiment, the method 400 is performed by a processing logic comprising hardware, software, firmware, or a combination thereof. The processing logic may be a controller, such as the memory sub-system controller 112 or local media controller 132 of FIG. 1, a processing device, a computing device, or other electronic devices. In some embodiments, the processing logic may be comprised of multiple processing devices. In at least one embodiment, a computing system performs the operations of the program trim manager 114, such as the computing system 100 of FIG. 1 or computer system 500 of FIG. 5.

At block 402, the processing logic may receive a write command to be performed on a set of memory cells of a memory device. The write command may be of a first type or a second type.

At block 404, the processing logic may select, based on the write command, one of a first set of trim values corresponding to the first type or a second set of trim values corresponding to the second type. The second set of trim values may correspond to a higher or enhanced endurance characteristic of the memory device than the first set of trim values.

At block 406, the processing logic may execute the write command with the selected set of trim values.

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the program trim manager 114 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 512, which communicate with each other via a bus 518.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 516 for performing the operations and steps discussed herein. The computer system 500 can further include a network interface device 508 to communicate over the network 510.

The data storage system 512 can include a machine-readable storage 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage 514, data storage system 512, and/or main memory 504 can correspond to the memory sub-system 110 of FIG. 1.

In one embodiment, the instructions 516 include instructions to implement functionality corresponding to a voltage bin boundary component (e.g., the program trim manager 114 of FIG. 1). While the machine-readable storage 514 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings arc, accordingly, to be regarded in an illustrative sense rather than a restrictive sense.

What is claimed is:

1. A system, comprising:
a memory device; and
a controller, coupled to the memory device, wherein the controller is configured to:
receive a write command;
select, based on a type of the write command, one of: a first set of trim values corresponding to a first type of the write command or a second set of trim values corresponding to a second type of the write command, wherein the second set of trim values corresponds to a higher endurance characteristic of the memory device than the first set of trim values; and
executing the write command with the selected set of trim values.

2. The system of claim 1, wherein the first set of trim values is stored by a plurality of fuses within the memory device, and executing the write command with the second set of trim values comprises enabling a latch coupled to at least one of the plurality of fuses.

3. The system of claim 1, wherein the first set of trim values comprises a first start voltage which is higher than a second start voltage of the second set of trim values.

4. The system of claim 1, wherein the first set of trim values comprises a first step voltage which is higher than a second step voltage of the second set of trim values.

5. The system of claim 1, wherein the first set of trim values comprises a first ramp up time of a voltage pulse which is shorter than a second ramp up time of a voltage pulse of the second set of trim values.

6. The system of claim 1, wherein a first write command of the first type is generated by a host device coupled to the controller and a second write command of the second type is generated by the controller.

7. The system of claim 6, wherein the first type of write command is one of a critical flash translation layer (FTL) journal write, a media management operation, or an error handling operation.

8. A method comprising:
receiving, by a controller, a write command to be performed on a set of memory cells of a memory device;
selecting, based on the write command, one of: a first set of trim values corresponding to a first type of the write command or a second set of trim values corresponding to a second type of the write command, wherein the second set of trim values corresponds to a higher endurance characteristic of the memory device than the first set of trim values; and
executing the write command with the selected set of trim values.

9. The method of claim 8, wherein the first set of trim values is stored by a plurality of fuses, and executing the write command with the second set of trim values comprises enabling a latch coupled to at least one of the plurality of fuses.

10. The method of claim 8, wherein the first set of trim values comprises a first start voltage which is higher than a second start voltage of the second set of trim values.

11. The method of claim 8, wherein the first set of trim values comprises a first step voltage which is higher than a second step voltage of the second set of trim values.

12. The method of claim 8, wherein the first set of trim values comprises a first ramp up time of a voltage pulse which is shorter than a second ramp up time of a voltage pulse of the second set of trim values.

13. The method of claim 8, wherein a first write command of the first type is generated by a host device coupled to the controller and a second write command of the second type is generated by the controller.

14. The method of claim 13, wherein the first type of write command is one of a critical flash translation layer (FTL) journal write, a media management operation, or an error handling operation.

15. A method, comprising:
receiving, by a controller from a host device, a first write command to be performed on a set of memory cells within a memory device;
executing, in response to a determination that the first write command is of a first type, the first write command using first trim values;
determining, by the controller, that a second write command is to be performed on a second unit of memory within the memory device; and
executing, in response to a determination that the second write command is of a second type, the second write command using second trim values, wherein the second trim values corresponds to a higher endurance characteristic of the memory device than the first trim values.

16. The method of claim 15, wherein the first trim values is stored by a plurality of fuses of the memory device, and wherein the method further comprises generating the second trim values by enabling a latch coupled to at least one of the plurality of fuses.

17. The method of claim 15, wherein the first trim values comprises a first start voltage which is higher than a second start voltage of the second trim values.

18. The method of claim 15, wherein the first trim values comprises a first step voltage which is higher than a second step voltage of the second trim values.

19. The method of claim 15, wherein the first trim values comprises a first ramp up time of a voltage pulse which is shorter than a second ramp up time of a voltage pulse of the second trim values.

20. The method of claim 15, wherein the second write command is one of a critical flash translation layer (FTL) journal write, a media management operation, or an error handling operation.
